(19) United States
(12) Patent Application Publication
(10) Pub. No.: US 2026/0108986 A1
(43) Pub. Date: Apr. 23, 2026

(54) LASER WELDING METHOD AND METHOD FOR MANUFACTURING ROTARY ELECTRICAL MACHINE

(71) Applicant: KABUSHIKI KAISHA TOSHIBA, Kawasaki-shi (JP)

(72) Inventors: Tomoki TSUKADA, Yokohama (JP); Masakazu KIKAWADA, Yokohama (JP)

(73) Assignee: KABUSHIKI KAISHA TOSHIBA, Kawasaki-shi (JP)

(21) Appl. No.: 19/429,159

(22) Filed: Dec. 22, 2025

Related U.S. Application Data
(63) Continuation of application No. PCT/JP2023/029529, filed on Aug. 15, 2023.

(51) Int. Cl. B23K 26/21; B23K 101/36

(52) U.S. Cl. CPC B23K 26/21; B23K 2101/36

(57) ABSTRACT

According to one embodiment: a process of forming a first weld pool by alternately irradiating a laser light on an end part of a first wire-shaped member and an end part of a second wire-shaped member, in which the first weld pool straddles the end part of the first wire-shaped member and the end part of the second wire-shaped member, and the second wire-shaped member is adjacent to the first wire-shaped member; and a process of irradiating the laser light on the first weld pool. The process of irradiating the laser light on the first weld pool includes setting a central vicinity of the first weld pool as a start point of the irradiation of the laser light, and moving an irradiation position of the laser light away from the start point so that the irradiation position moves away gradually or in stages while turning around the start point.

### CROSS-REFERENCE TO RELATED APPLICATIONS

This application is based upon and claims the benefit of priority from the PCT Patent Application PCT/JP2023/029529, filed on Aug. 15, 2023; the entire contents of which are incorporated herein by reference.

### FIELD

Embodiments of the invention relate to a laser welding method and a method for manufacturing a rotary electrical machine.

### BACKGROUND

For example, technology has been proposed in which two wire-shaped members are arranged proximate to each other, and a laser light is irradiated on an end part of one wire-shaped member and an end part of another wire-shaped member adjacent to the one wire-shaped member to weld the end parts of the two wire-shaped members to each other. In such a case, if there is a gap between the end parts of the two wire-shaped members, there is a risk that the laser light may leak through the gap between the end parts. If the laser light leaks through the gap between the end parts, for example, there are cases where the laser light is incident on a coating located at the side surface of the wire-shaped member and/or on a member located proximate to the wire-shaped member. If the laser light is incident on the coating and/or member, there is a risk that the coating and/or member may be damaged by the laser light.

Therefore, technology has been proposed in which the laser light is individually irradiated on each of the end parts of the two wire-shaped members. Thus, the incidence of the laser light on the coating and/or member via the gap between the end parts of the wire-shaped members can be suppressed.

However, it has been determined that this laser light path has little effect in suppressing the formation of blow holes in the weld portion. If blow holes form, the tensile strength of the weld portion is reduced, resulting in degradation of the reliability of the joint. Also, because blow holes are not formed intentionally, the size, number, occurrence positions, etc., of blow holes are random. Therefore, fluctuation of the weld portion quality easily increases.

It is therefore desirable to develop technology that can suppress the formation of blow holes in the weld portion.

### BRIEF DESCRIPTION OF THE DRAWINGS

FIG. 1 is a schematic perspective view illustrating a stator.

FIG. 2 is a schematic view illustrating a segment before being mounted to a core.

FIG. 3 is a schematic view illustrating a coil mounted to the core.

FIG. 4 is a schematic view illustrating the formation of a weld pool.

FIG. 5 is a schematic view illustrating a movement path of an irradiation position of a laser light.

FIG. 6 is a schematic view illustrating a movement path of the irradiation position of the laser light.

FIG. 7 is a schematic view illustrating a movement path of the irradiation position of the laser light according to another embodiment.

FIG. 8 is a schematic view illustrating a movement path of the irradiation position of the laser light according to another embodiment.

FIGS. 9A and 9B are photographs of cross sections of a boundary between a weld portion and end parts of two conductor parts.

FIG. 10 is a photograph of a cross section of a boundary between a weld portion and end parts of two conductor parts.

### DETAILED DESCRIPTION

A laser welding method according to an embodiment includes: a process of forming a first weld pool by alternately irradiating a laser light on an end part of a first wire-shaped member and an end part of a second wire-shaped member, in which the first weld pool straddles the end part of the first wire-shaped member and the end part of the second wire-shaped member, and the second wire-shaped member is adjacent to the first wire-shaped member; and a process of irradiating the laser light on the first weld pool. The process of irradiating the laser light on the first weld pool includes setting a central vicinity of the first weld pool as a start point of the irradiation of the laser light, and moving an irradiation position of the laser light away from the start point so that the irradiation position moves away gradually or in stages while turning around the start point.

A laser welding method according to the embodiment can be used when end parts of wire-shaped members arranged proximate to each other are welded to each other. For example, a rotary electrical machine such as a motor, a generator, or the like includes a coil wound onto a core. In recent years, a coil that is wound onto a core is formed by inserting multiple segments into slots, and subsequently welding by irradiating a laser light on an end part of a segment and on an end part of a segment adjacent to the segment. Therefore, as an example below, the laser welding method according to the embodiment is described while illustrating a method for manufacturing a stator. In other words, the invention is applicable to a method for manufacturing a rotary electrical machine.

Also, although a wire-shaped member that has a quadrilateral cross-sectional shape is illustrated to illustrate the method for manufacturing the stator, the invention also is applicable to a wire-shaped member having, for example, a polygonal cross-sectional shape, etc.

Also, in the specification, the movement path of the irradiation position of the laser light is the movement path along which the center of the laser spot moves when the laser light is irradiated; and when the irradiation of the laser light is stopped, the movement path of the irradiation position is the movement path along which the center of the laser spot would move if the laser spot is assumed to be formed. For example, the movement path of the irradiation position of the laser light can be predetermined. For example, data of predetermined movement paths is stored in a controller of a laser welding machine, etc., and is used when performing the laser welding method described below. The movement path of the irradiation position of the laser light is described below.

Embodiments will now be illustrated with reference to the drawings. Similar components in the drawings are marked with the same reference numerals; and a detailed description is omitted as appropriate.

First, the stator 1 will be illustrated.

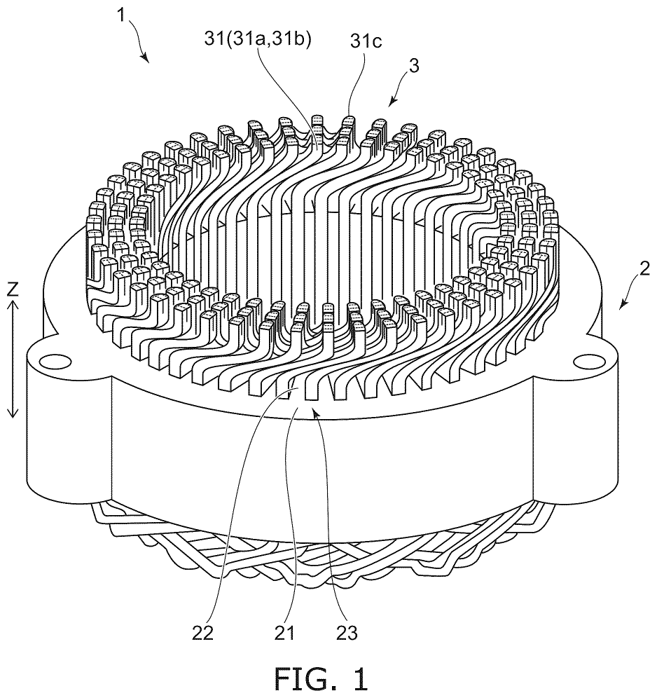

FIG. 1 is a schematic perspective view illustrating the stator 1.

As Shown in FIG. 1, the stator 1 includes a core 2 and a coil 3.

For example, the core 2 includes multiple ring-shaped magnetic members stacked in the axis direction of the stator 1 (in FIG. 1, a Z-direction). For example, the magnetic member is formed from an electrical steel sheet (a silicon steel sheet). The core 2 includes a yoke 21 and multiple teeth 22. The yoke 21 is tubular and is positioned at the outer circumference side of the core 2. The multiple teeth 22 are located at the inner circumferential surface of the yoke 21 at uniform spacing. Each of the multiple teeth 22 has a configuration that protrudes from the inner circumferential surface of the yoke 21 toward the center of the core 2 and extends in the axis direction of the stator 1. Also, a groove that is located between the tooth 22 and the tooth 22 is used as a slot 23. The shapes, number, and sizes of the teeth 22 are not limited to those illustrated and can be modified as appropriate according to the application, size, specifications, etc., of the rotary electrical machine including the stator 1.

The coil 3 includes multiple segments 31.

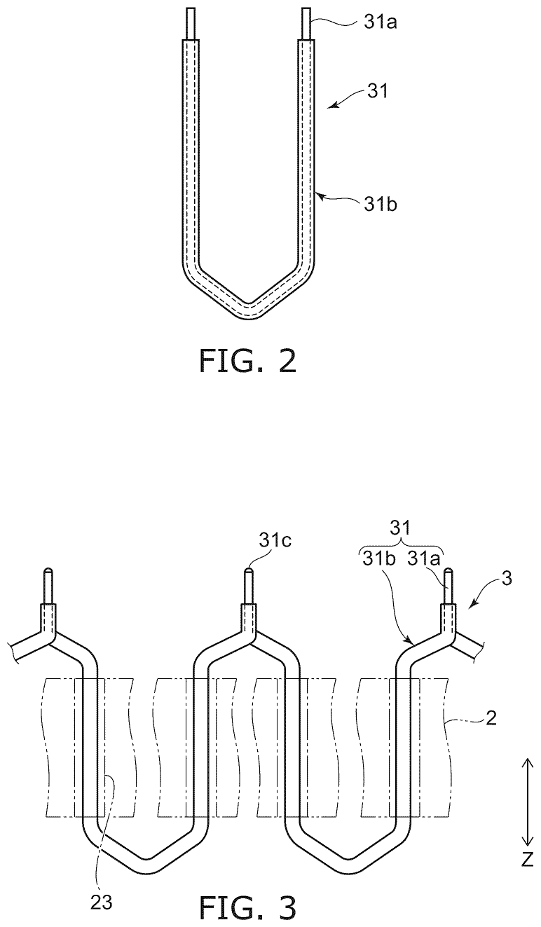

FIG. 2 is a schematic view illustrating the segment 31 before being mounted to the core 2.

As shown in FIG. 2, the segment 31 includes a conductor part 31a (corresponding to an example of a first wire-shaped member and a second wire-shaped member) and an insulating film 31b. The exterior shape of the conductor part 31a before being mounted to the core 2 can be substantially U-shaped. The conductor part 31a is formed from a material having a high conductivity. For example, the conductor part 31a is formed from so-called pure copper or a material having copper as a major component. Also, the conductor part 31a can be formed from a rectangular wire. The rectangular wire is a wire-shaped member having a quadrilateral cross section. The cross-sectional dimensions of the rectangular wire can be, for example, about 1 mm to 4 mm.

The insulating film 31b covers the outer surface of the conductor part 31a. However, proximate to the two end parts of the conductor part 31a, the insulating film 31b is not provided, and the conductor part 31a is exposed. The insulating film 31b includes, for example, enamel, etc.

FIG. 3 is a schematic view illustrating the coil 3 mounted to the core 2.

As shown in FIG. 3, the segment 31 is located inside the slot 23. The two ends of the segment 31 protrude from one end part of the core 2. The portion of the segment 31 protruding from the one end part of the core 2 extends in a direction toward the adjacent segment 31.

Also, the vicinity of the portion of the conductor part 31a exposed from under the insulating film 31b extends in the axis direction of the core 2 (in FIG. 3, the Z-direction). The portion of the conductor part 31a exposed from under the insulating film 31b overlaps the portion of the adjacent conductor part 31a exposed from under the insulating film 31b in the circumferential direction of the core 2 (a direction around the central axis of the core 2).

The end parts of the adjacent conductor parts 31a are laser-welded to each other. One coil 3 is formed by the multiple segments 31 being connected via a weld portion 31c.

In such a case, the multiple coils 3 can be arranged in the radial direction of the core 2 (a direction passing through the central axis of the core 2 orthogonal to the Z-direction). For example, the three coils 3 of a U-phase, a V-phase, and a W-phase can be included. The exterior shapes, numbers, sizes, etc., of the coils 3 and the segments 31 are not limited to those illustrated and can be modified as appropriate according to the application, size, specifications, etc., of the rotary electrical machine including the stator 1. For example, four coils 3 may be arranged in the radial direction of the core 2.

A method for manufacturing the stator 1 will now be illustrated.

First, the core 2 is formed. For example, multiple plate-shaped magnetic members that include portions used to form the yoke 21 and the multiple teeth 22 are formed. For example, the magnetic member is formed by stamping an electrical steel sheet having a thickness of about 0.05 mm to 1.0 mm. Then, the multiple magnetic members are stacked, and the core 2 is formed by, for example, welding and/or caulking the multiple magnetic members. The core 2 also can be formed by press forming a magnetic material powder and a resin binder.

Then, multiple segments 31 that are used as components of the coil 3 are formed.

First, the insulating film 31b is formed by applying a coating including enamel, etc., on the outer surface of a rectangular wire. A rectangular wire to which an enamel coating or the like is applied may be procured.

Then, the insulating film 31b proximate to the two end parts of the conductor part 31a is stripped away to expose the conductor part 31a. Subsequently, the conductor part 31a is cut to the prescribed length at the portions at which the conductor part 31a is exposed. The conductor part 31a on which the insulating film 31b is formed may be cut to the prescribed length, followed by stripping away the insulating film 31b proximate to the two end parts of the cut portions. Also, the stripping away of the insulating film 31b and the cutting of the conductor part 31a may be simultaneously performed.

Continuing as shown in FIG. 2, the conductor part 31a is formed by bending the conductor part 31a of which the vicinities of the two end parts are exposed from under the insulating film 31b into a substantially U-shape.

Thus, multiple segments 31 can be formed.

Then, as shown in FIG. 3, each of the multiple segments 31 is mounted in prescribed slots 23 of the core 2. For example, each of the multiple segments 31 is inserted into the prescribed slots 23 from the axis direction of the core 2 (in FIG. 1, the Z-direction). In such a case, one segment 31 is inserted to straddle multiple slots 23. The coil 3 according to the embodiment can be a coil that has so-called distributed winding. Also, the coil 3 according to the embodiment can be a coil that has so-called wave winding.

Continuing as shown in FIG. 3, the portion of the segment 31 protruding from the core 2 is bent in a direction toward the adjacent segment 31. Then, furthermore, the vicinity of the portion of the conductor part 31a exposed from under the insulating film 31b is bent in the axis direction of the core 2 (in FIG. 3, the Z-direction). The portion of the conductor part 31a exposed from under the insulating film 31b overlaps the portion of the adjacent conductor part 31a exposed from under the insulating film 31b in the circumferential direction of the core 2. Then, by repeatedly performing the procedure described above, multiple sets of the multiple segments 31 arranged in the circumferential direction of the core 2 are arranged in the radial direction of the core 2.

Although a case is illustrated where the bending is performed after mounting the multiple segments 31 in the slots 23, the bending is not limited thereto. For example, the bending of the multiple segments 31 can be performed, and each of the multiple segments 31 on which the bending is performed can be mounted in the prescribed slots 23. In such a case, the segment 31 on which the bending is performed can be mounted outward from the inner side of the core 2.

Also, the openings of the slots 23 can be covered by providing a tubular insulating cover at the inner side of the core 2 in which the multiple segments 31 are mounted.

Then, the multiple coils 3 that are mounted in the slots 23 are formed by welding the end parts of the adjacent segments 31 (conductor parts 31a) to each other.

When welding, a jig can be used to cause the end parts of the adjacent conductor parts 31a to approach each other. For example, a jig that includes a ring-shaped member located at the inner side of the multiple segments 31 arranged in the circumferential direction of the core 2 and a ring-shaped member located at the outer side of the multiple segments 31 can be used. When the ring-shaped member located at the inner side of the multiple segments 31 is mounted, one end part of each of the multiple conductor parts 31a is pressed toward the outer side of the core 2. When the ring-shaped member located at the outer side of the multiple segments 31 is mounted, the other end part of each of the multiple conductor parts 31a is pressed toward the inner side of the core 2. Therefore, the jig moves the end parts of the adjacent conductor parts 31a in directions toward each other. Also, the multiple conductor parts 31a are held by the jig.

The configuration of the jig is not limited to that of the example. It is sufficient for the jig to cause the end parts of the adjacent conductor parts 31a to approach each other. Also, welding can be performed without using a jig. However, by using a jig, the quality of the weld portion 31c can be improved, and/or the ease of work of the welding operation can be improved.

The welding of the end parts of the adjacent conductor parts 31a to each other can be performed by irradiating a laser light on the end parts of the conductor parts 31a. In other words, the end parts of the adjacent conductor parts 31a can be laser-welded to each other.

A laser light in the infrared region or a laser light of a shorter wavelength in the blue to green region can be used in the laser welding. By using a laser light of a wavelength in the infrared region, it is easy to irradiate a laser light having a relatively high output. For example, the output of the laser light can be about 4 kW.

The laser welding machine that is used to weld the end parts of the conductor part 31a can be, for example, a fiber laser (fiber laser) welding machine, a disk laser (disk laser) welding machine, etc. It is favorable for the laser welding machine to be a CW laser (continuous wave laser) welding machine that can continuously emit a laser light. Also, the irradiation position of the laser light is movable in the laser welding machine. For example, the laser welding machine can include a galvano mirror, etc.

The weld portion 31c illustrated in FIGS. 1 and 3 is formed by welding the end parts of the adjacent conductor parts 31a to each other. Also, one coil 3 is formed by connecting the multiple segments 31 (the conductor parts 31a) in series. Also, the multiple coils 3 that are arranged in the radial direction of the core 2 are formed. For example, the three coils 3 of the U-phase, the V-phase, and the W-phase can be formed.

Then, the exposed portions of the conductor parts 31a of the coil 3 are insulated by coating a resin, etc.

Then, the multiple coils 3 are fixed to the core 2. For example, varnish is dropped into the gaps between the coil 3 and the slots 23; and the coil 3 is fixed to the core 2 by curing the varnish.

Thus, the stator 1 can be manufactured.

Here, if there is a gap between the end parts of the adjacent conductor parts 31a, there are cases where the laser light may be incident on the insulating film 31b of the segment 31 and/or a member located proximate to the segment 31 via the gap. If the laser light is incident on the insulating film 31b and/or the member, there is a risk that the insulating film 31b and/or the member may be damaged by the laser light.

In such a case, the gap between the end parts of the adjacent conductor parts 31a can be reduced by using the jig described above. However, the end part of the conductor part 31a includes fluctuation of the dimensions, fluctuation of the shape, deformation, etc. Therefore, even when the jig is used, it is difficult to eliminate the gap between the end parts of the adjacent conductor parts 31a.

Also, if the laser light is individually irradiated on each of the two end parts of the adjacent conductor parts 31a, the laser light can be prevented from being incident on the insulating film 31b and/or the member via the gap. However, by doing so, blow holes form easily in the weld portion 31c; and the welding time also increases.

Therefore, in the laser welding method according to the embodiment, the end parts of the adjacent conductor parts 31a are welded to each other as follows.

First, the laser light is alternately irradiated on the end part of the conductor part 31a and the end part of the conductor part 31a adjacent to the conductor part 31a to form a weld pool 101 (corresponding to an example of a first weld pool) straddling the end part of one conductor part 31a and the end part of the other conductor part 31a.

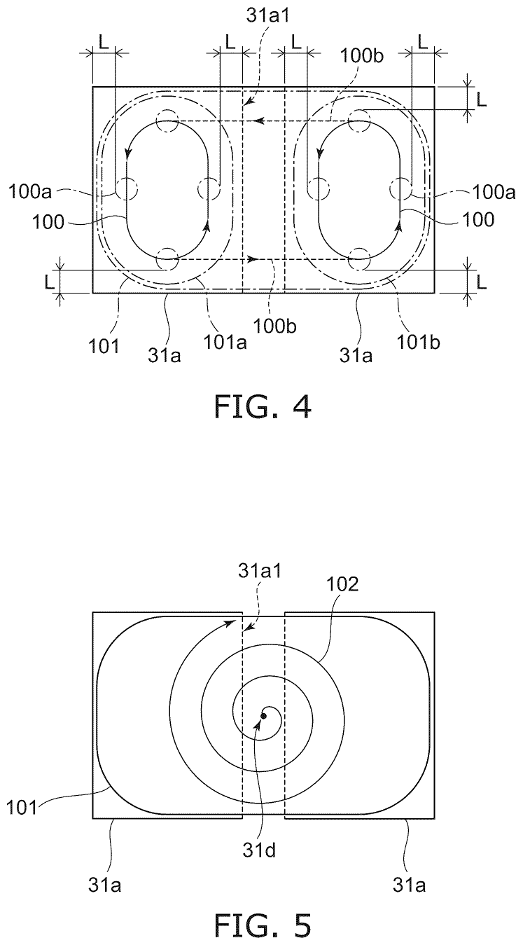

FIG. 4 is a schematic view illustrating the formation of the weld pool 101.

Although FIG. 4 illustrates a case where a gap 31a1 is formed between the end parts of the conductor parts 31a, the formation can be similar when, for example, the jig described above is used so that the end parts of the conductor parts 31a contact each other (when there is no gap 31a1).

As shown in FIG. 4, the laser light is alternately irradiated on the end part of the one conductor part 31a and the end part of the other conductor part 31a adjacent to the one conductor part 31a. By alternately irradiating the laser light, the end parts of the two conductor parts 31a each are melted to form two weld pools 101a and 101b (corresponding to an example of a second weld pool and a third weld pool). The weld pools 101a and 101b gradually become larger as the melting of the end parts of the two conductor parts 31a proceeds. As the weld pools 101a and 101b become larger, the weld pools 101a and 101b unite to form the weld pool 101 that straddles the two end parts. At this time, the opening of the gap 31a1 is covered with the weld pool 101.

In such a case, for example, the irradiation of the laser light can be performed by the following procedure.

First, as shown in FIG. 4, the laser light is irradiated at the end part of one conductor part 31a along a loop-shaped movement path 100 of the irradiation position of the laser light.

Then, the irradiation of the laser light is stopped, and the irradiation position of the laser light is moved from the end part of the one conductor part 31a to the end part of the other conductor part 31a along a linear movement path 100b of the irradiation position of the laser light.

Continuing, the irradiation of the laser light is restarted at the end part of the other conductor part 31a; and the laser light is irradiated along a loop-shaped movement path 100 of the irradiation position of the laser light.

Then, the irradiation of the laser light is stopped, and the irradiation position of the laser light is moved from the end part of the other conductor part 31a to the end part of the one conductor part 31a along a linear movement path 100b of the irradiation position of the laser light.

For example, the movement of the irradiation position of the laser light can be performed by a galvano mirror or the like located in the laser welding machine.

As described above, in the process of forming the weld pool 101 straddling the two end parts, the irradiation of the laser light is stopped when the irradiation position of the laser light is moved from the one end part to the other end part. Therefore, even when the gap 31a1 is formed between the end parts, the laser light can be prevented from being incident on the insulating film 31b and/or members via the gap 31a1.

Also, by repeating the procedure described above multiple times, the weld pools 101a and 101b are formed respectively at the two end parts. The weld pools 101a and 101b gradually become larger as the melting of the two end parts proceeds, and the weld pools 101a and 101b thereby unite to form the weld pool 101 straddling the two end parts. At this time, the opening of the gap 31a1 is covered with the weld pool 101.

In such a case, the loop-shaped movement paths 100 of the irradiation position may have the same shape and size, or at least one of the shape or size may be different.

For example, if the cross-sectional shape and cross-sectional dimensions are the same between the adjacent wire-shaped members (conductor parts 31a), the shape and size of the movement path 100 can be the same. For example, if at least one of the cross-sectional shape or cross-sectional dimensions is different between the adjacent wire-shaped members, at least one of the shape or size of the movement path 100 can be different.

Also, the shape of the movement path 100 is not particularly limited. The shape of the movement path 100 can be a circle, ellipse, or other shape including curves, a shape including curves and straight lines as illustrated in FIG. 4, or a shape including straight lines such as a quadrilateral or other polygon. If, however, the shape of the movement path 100 has corners, spatter occurs easily when the laser light is irradiated on the corners of the movement path 100. It is therefore favorable for the shape of the movement path 100 to be a shape including curves or a shape including curves and straight lines.

Also, the size of the loop-shaped movement path 100 of the irradiation position is not particularly limited. However, as illustrated in FIG. 4, at the end part of one conductor part 31a, it is favorable for a shortest distance L between the outer edge of a laser spot 100a and the outer edge of the end part of the one conductor part 31a to be constant. Also, at the end part of the other conductor part 31a, it is favorable for the shortest distance L between the outer edge of the laser spot 100a and the outer edge of the end part of the other conductor part 31a to be constant.

Also, when moving the loop-shaped movement path 100 of the irradiation position at the end part of the one conductor part 31a to the loop-shaped movement path 100 of the irradiation position at the end part of the other conductor part 31a, for example, as shown in FIG. 4, a pair of linear movement paths 100b of the irradiation position can be provided in which the loop-shaped movement path 100 of the irradiation position at the end part of the one conductor part 31a and the loop-shaped movement path 100 of the irradiation position at the end part of the other conductor part 31a are connected in the direction in which the end parts of the adjacent conductor parts 31a are arranged. The movement path 100b can be a straight line (an external common tangent) tangent to the two loop-shaped movement paths 100. The irradiation of the laser light is stopped along the movement path 100b of the irradiation position.

Also, heating of the end parts of the conductor parts 31a is performed along the movement paths 100. Therefore, the heating of the end parts of the conductor parts 31a is not suppressed even when the irradiation of the laser light is stopped and the irradiation of the laser light is restarted at positions separated from the outer edge of the end part of the conductor part 31a in the direction in which the end parts of the adjacent conductor parts 31a are arranged. For example, in the direction in which the end parts of the adjacent conductor parts 31a are arranged, the position at which the irradiation of the laser light is stopped can be substantially the center of the end part of the one conductor part 31a; and the position at which the irradiation of the laser light is restarted can be substantially the center of the end part of the other conductor part 31a. Therefore, the irradiation of the laser light via the gap 31a1 can be effectively suppressed even if there is fluctuation of the dimensions, fluctuation of the shape, deformation, etc., of the end part of the conductor part 31a or fluctuation of the dimensions of the gap 31a1.

Also, as shown in FIG. 4, by setting the shortest distance L between the outer edge of the laser spot 100a and the outer edge of the end part of the conductor part 31a to be a constant, the irradiation of the laser light via the gap 31a1 can be more effectively suppressed.

Also, if the loop-shaped movement path 100 of the irradiation position has the same shape and the same size between the end parts of the adjacent conductor parts 31a, the control program for the irradiation of the laser light can be simplified.

Also, if the movement path 100b of the irradiation position is a straight line (an external common tangent) tangent to the two loop-shaped movement paths 100 of the irradiation position, a linear movement is possible from one movement path 100 of the irradiation position to the other movement path 100 of the irradiation position. Therefore, the movement time from the one movement path 100 of the irradiation position to the other movement path 100 of the irradiation position can be reduced, which in turn can reduce the takt time.

Here, when the laser light is irradiated to form the two weld pools 101a and 101b, a gas (e.g., air, etc.) proximate to the end parts of the conductor parts 31a is trapped inside the weld pools 101a and 101b. In such a case, even when the weld pools 101a and 101b unite to form the weld pool 101 straddling the two end parts, the trapped gas remains inside the weld pool 101. If there is a gas inside the weld pool 101, a blow hole is formed inside the weld portion 31c when the weld pool 101 cools and the weld portion 31c is formed. If a blow hole is formed, the tensile strength of the weld portion 31c is reduced, and so the reliability of the joint is degraded. Also, blow holes are not intentionally formed, and so the size, number, occurrence positions, etc., of blow holes are random. Therefore, fluctuation of the quality of the weld portion 31c easily increases.

Therefore, next, the laser light is irradiated on the weld pool 101 to discharge the gas out of the weld pool 101 from inside the weld pool 101.

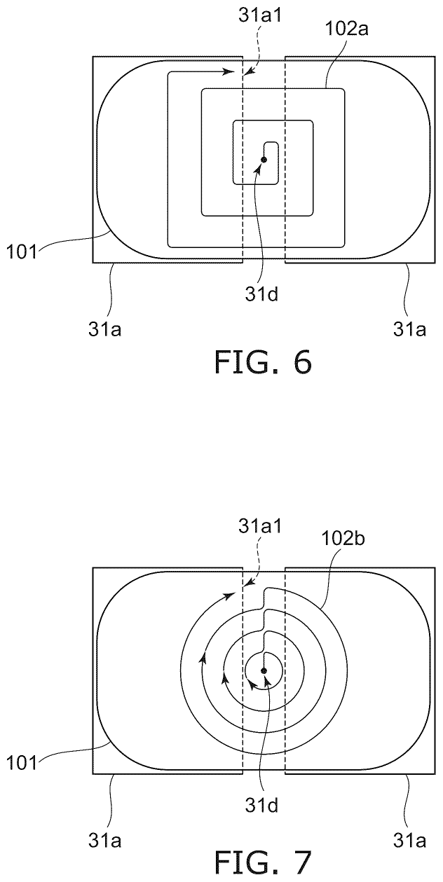

FIGS. 5 and 6 are schematic views illustrating movement paths of the irradiation position of the laser light.

First, as shown in FIGS. 5 and 6, the central vicinity of the weld pool 101 is set as a start point 31d of the irradiation of the laser light. The start point 31d of the irradiation of the laser light can be set to a position between the end part of the one conductor part 31a and the end part of the other conductor part 31a (e.g., the center of the gap 31a1). As described above, the opening of the gap 31a1 is covered with the weld pool 101. Therefore, the laser light is irradiated on the weld pool 101, and so even though the start point 31d is positioned above the gap 31a1, the irradiation of the laser light on the insulating film 31b, etc., via the gap 31a1 can be suppressed.

The end point of the irradiation of the laser light can be set to a position at the end part of the one conductor part 31a or a position at the end part of the other conductor part 31a.

Then, the irradiation position of the laser light is moved. In such a case, as shown in FIG. 5, the irradiation position of the laser light can gradually move away from the start point 31d while turning around the start point 31d. In such a case, the shape of a movement path 102 of the irradiation position of the laser light can have a shape including curves that gradually moves away from the start point 31d while turning around the start point 31d. For example, as shown in FIG. 5, the shape of the movement path 102 of the irradiation position of the laser light can be a spiral shape.

Also, as shown in FIG. 6, the shape of a movement path 102a of the irradiation position of the laser light can be a shape including straight lines that gradually move away from the start point 31d while turning around the start point 31d. For example, as shown in FIG. 6, the shape of the movement path 102a of the irradiation position of the laser light can be a quadrilateral spiral shape.

Also, the shape of the movement path of the irradiation position of the laser light can be a shape including curves and straight lines that gradually move away from the start point 31d while turning around the start point 31d.

In other words, it is sufficient for the irradiation position of the laser light to gradually move away from the start point 31d while turning around the start point 31d.

However, as described above, if the shape of the movement path has corners, spatter easily occurs when irradiating the laser light on the corners of the movement path. It is therefore favorable for the shape of the movement path to be a shape including curves or a shape including curves and straight lines.

Also, the turning direction of the movement path is not particularly limited. For example, the turning direction may be clockwise or counterclockwise.

By setting the shape of the movement path of the irradiation position of the laser light to be a shape that gradually moves away from the start point 31d while turning around the start point 31d, a flow can be formed from the center toward the perimeter edge inside the weld pool 101. Therefore, the gas that is included inside the weld pool 101 can be discharged outside the weld pool 101.

Also, the weld pool 101 can be pressed and spread outward by the flow inside the weld pool 101 (the flow from the center toward the perimeter edge) and the impact when the laser light is incident. Therefore, the weld pool 101, and thereby the weld portion 31c, can be provided in substantially the entire regions of the end parts of the two conductor parts 31a.

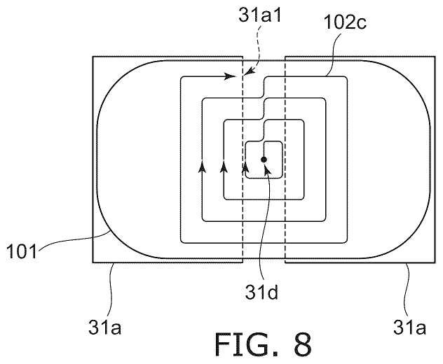

FIGS. 7 and 8 are schematic views illustrating movement paths of the irradiation position of the laser light according to other embodiments.

As shown in FIG. 7, the shape of a movement path 102b of the irradiation position of the laser light can be multiple circles that become larger in stages. For example, the shape of the movement path 102b can be concentric circles centered on the start point 31d. In such a case, the irradiation position is moved sequentially from the movement path 102b proximate to the start point 31d to the movement path 102b adjacent to the outside of the movement paths 102b.

As shown in FIG. 8, the shape of a movement path 102c of the irradiation position of the laser light can be multiple polygons that become larger in stages. For example, the shape of the movement path 102b can be concentric polygons centered on the start point 31d. The shape of the movement path 102c illustrated in FIG. 8 is concentric quadrilaterals centered on the start point 31d. In such a case, the irradiation position is moved sequentially from the movement path 102c proximate to the start point 31d to the movement path 102c adjacent to the outside of the movement path 102c.

Although cases are illustrated where the movement path is multiple circles and multiple polygons, it is sufficient for the shape of the movement path to be a shape including curves, a shape including straight lines, or a shape including curves and straight lines. However, as described above, to suppress the occurrence of spatter, it is favorable for the shape of the movement path to be a shape with no corners. Also, the turning direction of the movement path is not particularly limited. For example, the turning direction may be clockwise or counterclockwise.

As described above, the irradiation position of the laser light may move away from the start point 31d in stages while turning around the start point 31d.

In this way, effects similar to those described above can be realized. In other words, a flow from the center toward the perimeter edge can be formed inside the weld pool 101, and so a gas included inside the weld pool 101 can be discharged outside the weld pool 101. Also, the weld pool 101 can be pressed and spread outward, and so the weld pool 101, and thereby the weld portion 31c, can be provided in substantially the entire regions of the end parts of the two conductor parts 31a.

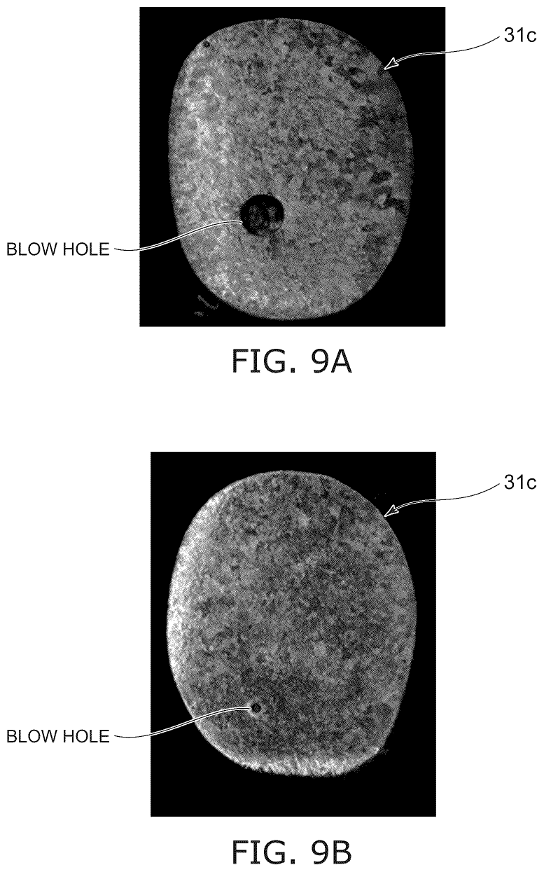

FIGS. 9A and 9B are photographs of cross sections of the boundary between the weld portion 31c and end parts of two conductor parts 31a. FIGS. 9A and 9B are cases where a process of discharging the gas out of the weld pool 101 from inside the weld pool 101 was not performed after the weld pool 101 was formed.

It can be seen from FIGS. 9A and 9B that a blow hole formed inside the weld portion 31c. Therefore, the tensile strength of the weld portion 31c decreased, resulting in degradation of the reliability of the joint.

Also, the sizes, number, occurrence positions, etc., of the blow holes that are formed are random. Therefore, fluctuation of the quality of the weld portion 31c easily increases.

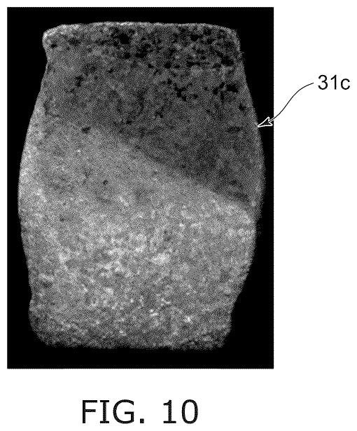

FIG. 10 is a photograph of a cross section of a boundary between the weld portion 31c and end parts of two conductor parts 31a. FIG. 10 is a case where a process of discharging the gas out of the weld pool 101 from inside the weld pool 101 is performed after the weld pool 101 is formed. It can be seen from FIG. 10 that if the process of discharging the gas out of the weld pool 101 from inside the weld pool 101 is performed, the formation of blow holes inside the weld portion 31c can be suppressed. Therefore, a reduction of the tensile strength of the weld portion 31c can be suppressed, and the reliability of the joint can be increased thereby. Also, fluctuation of the quality of the weld portion 31c can be reduced.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions, and are within the scope of the inventions described in the claims and their equivalents. Also, the embodiments above can be implemented in combination with each other.

What is claimed is:

1. A laser welding method, comprising:
forming a first weld pool by alternately irradiating a laser light on an end part of a first wire-shaped member and an end part of a second wire-shaped member, the first weld pool straddling the end part of the first wire-shaped member and the end part of the second wire-shaped member, the second wire-shaped member being adjacent to the first wire-shaped member; and
irradiating the laser light on the first weld pool,
the irradiating of the laser light on the first weld pool including
setting a central vicinity of the first weld pool as a start point of the irradiation of the laser light, and
moving an irradiation position of the laser light away from the start point so that the irradiation position moves away gradually or in stages while turning around the start point.

2. The laser welding method according to claim 1, wherein
the forming of the first weld pool includes uniting a second weld pool and a third weld pool to form the first weld pool,
the second weld pool is formed in the end part of the first wire-shaped member, and
the third weld pool is formed in the end part of the second wire-shaped member.

3. The laser welding method according to claim 1, wherein
in the irradiating of the laser light on the first weld pool, a shape of a movement path of the irradiation position of the laser light is a spiral shape.

4. The laser welding method according to claim 1, wherein
in the irradiating of the laser light on the first weld pool, a shape of a movement path of the irradiation position of the laser light is a plurality of circles becoming larger in stages, or a plurality of polygons becoming larger in stages.

5. The laser welding method according to claim 1, wherein
in the irradiating of the laser light on the first weld pool:
the start point of the irradiation of the laser light is a position between the end part of the first wire-shaped member and the end part of the second wire-shaped member; and
an end point of the irradiation of the laser light is a position at the end part of the first wire-shaped member, or a position at the end part of the second wire-shaped member.

6. The laser welding method according to claim 1, wherein
the irradiating of the laser light on the first weld pool includes discharging a gas out of the first weld pool from inside the first weld pool.

7. A method for manufacturing a rotary electrical machine, the method comprising:
disposing a coil in a plurality of slots,
the coil including a plurality of segments,
the disposing of the coil including welding end parts of conductor parts of the plurality of segments by using the laser welding method according to claim 1.
